(19) United States
(12) Patent Application Publication
(10) Pub. No.: US 2011/0172354 A1
(43) Pub. Date: Jul. 14, 2011

(54) ETHYLENE-BASED POLYMER COMPOSITIONS FOR USE IN FIBER APPLICATIONS

(75) Inventors: Gert J. Claasen, Richterswil (CH); Mehmet Demirors, Pearland, TX (US)

(73) Assignee: Dow Global Technologies Inc., Midland, MI (US)

(21) Appl. No.: 12/651,555

(22) Filed: Jan. 4, 2010

(51) Int. Cl. C08L 23/06; C08F 110/02; C08L 23/04

(52) U.S. Cl. 524/585; 526/352; 525/240; 526/65

(57) ABSTRACT

The present invention relates to particular ethylene-based polymer compositions suitable for use in binder fiber applications. The materials are characterized in having a peak recrystallization temperature in the range of from 85° C. to 110 C, and a Comonomer Distribution Constant (“CDC”) of 55 or greater. The materials are also characterized by having a tan delta value at 0.1 rad/sec from about 15 to 50, and a complex viscosity at 0.1 rad/second of 1400 Pa·sec or less.

### FIELD OF THE INVENTION

The present invention relates to particular ethylene-based polymer compositions suitable for use in binder fiber applications. The materials are characterized in having a peak recrystallization temperature in the range of from 85° C. to 110 C, and a Comonomer Distribution Constant (“CDC”) of 55 or greater. This class of materials offers a relatively low melting point, but is also suitable for fiber processing without the issues of fiber sticking during the spinning or nonwoven process. Additionally these material form good sheathing for bicomponent fibers. These fibers are also suitable for the airlaid process with a good low temperature bonding window without sticking problems generally associated with low melting materials.

### BACKGROUND AND SUMMARY OF THE INVENTION

Bicomponent fibers are commonly used for binder fibers such as those used in the manufacturing of feminine hygiene absorbent core pads. Many of these fibers comprise a polyethylene sheath with a polyester or polypropylene core. The incumbent polyethylenes typically used in such applications have recrystallization temperatures which are generally greater than 110° C. It would be desirable to lower the melting point of the polyethylene in order to allow faster line speeds due to lower binding temperature. This would also result in lower energy usage. However, lowering the melting point of the polyethylene is associated with processing problems. For widespread applicability for use in binder fibers the fiber should have the following characteristics: good spinning performance, such that smoke, fiber breaks and fibers sticking together are minimized during the spinning process; the fibers also need to have a low COF to allow the ability to be texturized; good fiber tensile properties; ability to be readily cut; ability to be used in the airlaid process and ability to be bonded using the thermal air bonding process at the lowest temperature without fibers becoming sticky. Additionally, the outer layer of the bi-component fiber should have good bonding to the inner core (substrate) as well as to other fibrous products.

A particular class of polyethylene resins have been discovered which performs in the binder fiber application. The ethylene-based polymer compositions can be further characterized as having a single differential scanning calorimetry (DSC) melting peak. The ethylene based polymer compositions can be characterized in having peak recrystallization temperature in the range of from 85° C. to 110° C.

### BRIEF DESCRIPTION OF THE DRAWING

FIG. 1 is a plot of comonomer distribution obtained from Crystallization Elution Fractionation which can be used for determining peak temperature, half width and median temperature.

### DETAILED DESCRIPTION OF THE INVENTION

### Definitions

The term “composition,” as used, includes a mixture of materials which comprise the composition, as well as reaction products and decomposition products formed from the materials of the composition.

The terms “blend” or “polymer blend,” as used, mean an intimate physical mixture (that is, without reaction) of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding) or the micro level (for example, simultaneous forming within the same reactor).

The term “long chain branched polymer” refers to polymers where polymer backbone of the polymer contains branches that are longer than the typically used comonomers (for example longer than 6 or 8 carbon atoms). A long chain branched polymer typically contains more than 0.2 long chain branches per 1000 carbon atoms.

The term “linear” refers to polymers where the polymer backbone of the polymer lacks measurable or demonstrable long chain branches, for example, the polymer can be substituted with an average of less than 0.01 long branch per 1000 carbons.

The term “polymer” refers to a polymeric compound prepared by polymerizing monomers, whether of the same or a different type. The generic term polymer thus embraces the term “homopolymer,” usually employed to refer to polymers prepared from only one type of monomer, and the term “interpolymer” as defined.

The term “interpolymer” refers to polymers prepared by the polymerization of at least two different types of monomers. The generic term interpolymer includes copolymers, usually employed to refer to polymers prepared from two different monomers, and polymers prepared from more than two different types of monomers. The term “ethylene-based polymer” refers to a polymer that contains more than 50 mole percent polymerized ethylene monomer (based on the total amount of polymerizable monomers) and, optionally, may contain at least one comonomer.

The compositions of the present invention are ethylene-based polymer compositions characterized by a Comonomer Distribution Constant greater than about 45, more preferably greater than 50, most preferably greater than 55, and as high as 400, more preferably as high as 100. The preferred ethylene-based polymer compositions are those made in high pressure reactors utilizing free radical polymerization process preferably using peroxide based free radical initiators The preferred polyethylene resins have a melt index (measured in accordance with ASTM D 1238, Condition 190° C./2.16 kg) in the range of from 5 to 25 g/10 min, more preferably 5 to 20. The preferred ethylenic resins have a density in the range of from 0.910 to 0.930 g/cm³, more preferably 0.915 to 0.925. The ethylene based polymer compositions can also be characterized in having peak recrystallization temperature in the range of from 85° C. to 110° C. Preferred resins of the present invention will also have a complex viscosity at 0.1 rad/second of 1400 Pa·sec or less, and at 100 rad/seconds of 500 Pa·sec or less. Preferably, the resins of the present invention will have a complex viscosity at 0.1 rad/second in the range of 500 to 1200 and at 100 rad/seconds in the range of from 150 to 450 Pa·sec. Preferred resins of the present invention will also have a Tan delta value at 0.1 rad/sec from about 15 to 50, more preferably 15 to 40. Preferred resins can be further characterized as having a single differential scanning calorimetry (DSC) melting peak.

In some processes, processing aids, such as plasticizers, can also be included in the ethylene based polymers of the present invention. These aids include, but are not limited to, the phthalates, such as dioctyl phthalate and diisobutyl phthalate, natural oils such as lanolin, and paraffin, naphthenic and aromatic oils obtained from petroleum refining, and liquid resins from rosin or petroleum feedstocks. Exemplary classes of oils useful as processing aids include white mineral oil such as KAYDOL oil (Chemtura Corp.; Middlebury, Conn.) and SHELLFLEX 371 naphthenic oil (Shell Lubricants; Houston, Tex.). Another suitable oil is TUFFLO oil (Lyondell Lubricants; Houston, Tex.).

In some processes, ethylenic polymers are treated with one or more stabilizers, for example, antioxidants, such as IRGANOX 1010 and IRGAFOS 168 (Ciba Specialty Chemicals; Glattbrugg, Switzerland). In general, polymers are treated with one or more stabilizers before an extrusion or other melt processes. In other embodiment processes, other polymeric additives include, but are not limited to, ultraviolet light absorbers, antistatic agents, pigments, dyes, nucleating agents, fillers, slip agents, fire retardants, plasticizers, processing aids, lubricants, stabilizers, smoke inhibitors, viscosity control agents surface modification and anti-blocking agents. The ethylenic polymer composition may, for example, comprise less than 10 percent by the combined weight of one or more additives, based on the weight of the embodiment ethylenic polymer.

The ethylenic polymer produced may further be compounded. In some ethylenic polymer compositions, one or more antioxidants may further be compounded into the polymer and the compounded polymer pelletized. The compounded ethylenic polymer may contain any amount of one or more antioxidants. For example, the compounded ethylenic polymer may comprise from about 200 to about 600 parts of one or more phenolic antioxidants per one million parts of the polymer. In addition, the compounded ethylenic polymer may comprise from about 800 to about 1200 parts of a phosphite-based antioxidant per one million parts of polymer.

The product of invention can be made using two or more reactors, one of which is a back mixed reactor with at least one reaction zone and a second reactor which is a laminar flow reactor with at least two reactions zones. The product can also advantageously be made in a typical tubular high pressure process with two or more reaction zones with ethylene pressure at the inlet in the range of 1800 bars to 3500 bars. The temperature at the inlet of the first reaction zone can advantageously be in the range of from 2000 bars to 3000. The start of polymerization temperature can be from 110° C. to 150° C. with the peak temperature from about 280° C. to 330° C. For the initiation of the reaction, a mixture of peroxides was used to achieve the desired reaction rate at a given temperature and pressure as is known in the art. The exact composition of the free radical peroxide initiator mixture can be determined based on the details of plant, process pressures, temperatures and residence times by those skilled in the art. For the production of the compositions of the present invention a mixture of tertiary butyl peroctoate and ditertiary butyl peroxide can advantageously be used in the first zone of the reactor in a ratio on the order of 14 to 3 based on volume. The same two peroxides can also used in the second reaction zone at a volume ratio of 1 to 1. The exact amounts will depend on the purity of reactors, the reactor characteristics and other process parameters and can be determined for each specific set up by those skilled in the art.

The second zone re-initiation temperature can be from about 160° C. to 230° C. with a peak temperature of from about 280° C. to 330° C. A mixture of methyl ethyl ketone and propylene can be used as chain transfer agent to control the molecular weight. The typical ranges can be from about 10 to 5000 volume ppm of methyl ethyl ketone and from about 0.1 volume % to 5 volume % propylene depending on the complex viscosity ranges desired Then the polymer was separated from process solvents and unreacted ethylene, palletized through an extruder and used without further processing.

Additives and adjuvants may also be added to the ethylenic polymer post-formation. Suitable additives include fillers, such as organic or inorganic particles, including clays, talc, titanium dioxide, zeolites, powdered metals, organic or inorganic fibers, including carbon fibers, silicon nitride fibers, steel wire or mesh, and nylon or polyester cording, nano-sized particles, clays, and so forth; tackifiers, oil extenders, including paraffinic or napthelenic oils; and other natural and synthetic polymers, including other polymers that are or can be made according to the embodiment methods.

Blends and mixtures of the ethylenic polymer with other polyolefins may be performed. Suitable polymers for blending with the embodiment ethylenic polymer include thermoplastic and non-thermoplastic polymers including natural and synthetic polymers. Exemplary polymers for blending include polypropylene, (both impact modifying polypropylene, isotactic polypropylene, atactic polypropylene, and random ethylene/propylene copolymers), various types of polyethylene, including high pressure, free-radical LDPE, Ziegler-Natta LLDPE, metallocene PE, including multiple reactor PE (“in reactor” blends of Ziegler-Natta PE and metallocene PE, such as products disclosed in U.S. Pat. Nos. 6,545,088 (Kolthammer, et al.); 6,538,070 (Cardwell, et al.); 6,566,446 (Parikh, et al.); 5,844,045 (Kolthammer, et al.); 5,869,575 (Kolthammer, et al.); and 6,448,341 (Kolthammer, et al.)), ethylene-vinyl acetate (EVA), ethylene/vinyl alcohol copolymers, polystyrene, impact modified polystyrene, ABS, styrene/butadiene block copolymers and hydrogenated derivatives thereof (SBS and SEBS), and thermoplastic polyurethanes. Homogeneous polymers such as olefin plastomers and elastomers, ethylene and propylene-based copolymers (for example, polymers available under the trade designation VERSIFY™ Plastomers & Elastomers (The Dow Chemical Company), SURPASS™ (Nova Chemicals), and VISTAMAXX™ (ExxonMobil Chemical Co.)) can also be useful as components in blends comprising the ethylenic polymer.

### Test Methods

### Density

Samples that are measured for density are prepared according to ASTM D 1928. Measurements are made within one hour of sample pressing using ASTM D792, Method B.

### Melt Index

Melt index, or I₂, is measured in accordance with ASTM D 1238, Condition 190° C./2.16 kg, and is reported in grams eluted per 10 minutes. I₁₀ is measured in accordance with ASTM D 1238, Condition 190° C./10 kg, and is reported in grams eluted per 10 minutes.

### DSC Crystallinity

Differential Scanning calorimetry (DSC) can be used to measure the melting and crystallization behavior of a polymer over a wide range of temperature. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (˜25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −40° C. at a 10° C./minute cooling rate and held isothermal at −40° C. for 3 minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tₘ), peak recrystallization temperature (Tₚ), heat of fusion (H_{f}) (in Joules per gram), and the calculated % crystallinity for polyethylene samples using Equation 2:

% Crystallinity=((H_{f})/(292 J/g))×100 (Eq. 2).

The heat of fusion (H_{f}) and the peak melting temperature are reported from the second heat curve. Peak recrystallization temperature is determined from the cooling curve as Tp.

### Dynamic Mechanical Spectroscopy (DMS) Frequency Sweep

Melt rheology, constant temperature frequency sweeps, were performed using a TA Instruments ARES rheometer equipped with 25 mm parallel plates under a nitrogen purge. Frequency sweeps were performed at 190° C. for all samples at a gap of 2.0 mm and at a constant strain of 10%. The frequency interval was from 0.1 to 100 radians/second. The stress response was analyzed in terms of amplitude and phase, from which the storage modulus (G′), loss modulus (G″), and dynamic melt viscosity (η*) were calculated.

### CEF Method

Comonomer distribution analysis is performed with Crystallization Elution Fractionation (CEF) (PolymerChar in Spain) (B Monrabal et al, Macromol. Symp. 257, 71-79 (2007)). Ortho-dichlorobenzene (ODCB) with 600 ppm antioxidant butylated hydroxytoluene (BHT) is used as solvent. Sample preparation is done with autosampler at 160° C. for 2 hours under shaking at 4 mg/ml (unless otherwise specified). The injection volume is 300 μl. The temperature profile of CEF is: crystallization at 3° C./min from 110° C. to 30° C., the thermal equilibrium at 30° C. for 5 minutes, elution at 3° C./min from 30° C. to 140° C. The flow rate during crystallization is at 0.052 ml/min. The flow rate during elution is at 0.50 ml/min. The data is collected at one data point/second.

CEF column is packed by the Dow Chemical Company with glass beads at 125 um±6% (MO-SCI Specialty Products) with ⅛ inch stainless tubing. Glass beads are acid washed by MO-SCI Specialty with the request from the Dow Chemical Company. Column volume is 2 06 ml. Column temperature calibration is performed by using a mixture of NIST Standard Reference Material Linear polyethylene 1475a (1.0 mg/ml) and Eicosane (2 mg/ml) in ODCB. Temperature is calibrated by adjusting elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0 mg/ml) and hexacontane (Fluka, purum, ≧97.0%, 1 mg/ml). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined as:

$$Resolution = \frac{\begin{matrix}Peak temperature of NIST 1475 a - \\ Peak Temperature of Hexacontane\end{matrix}}{\begin{matrix}Half \text{-} height Width of NIST 1475 a + \\ Half \text{-} height Width of Hexacontane\end{matrix}}$$

The column resolution is 6.0

### CDC Method

Comonomer distribution constant (CDC) is calculated from comonomer distribution profile by CEF. CDC is defined as Comonomer Distribution Index divided by Comonomer Distribution Shape Factor multiplying by 100 (Equation 1)

$$\begin{matrix}CDC = \frac{Comonomer Distrubution Index}{Comonomer Distribution Shape Factor} \\ = \frac{Comonomer Distribution Index}{Half Width \text{/} Stdev} * 100\end{matrix} \qquad Equation 1$$

Comonomer distribution index stands for the total weight fraction of polymer chains with the comonomer content ranging from 0.5 of median comonomer content (Cmedian) and 1.5 of Cmedian from 35.0 to 119.0° C. Comonomer Distribution Shape Factor is defined as a ratio of the half width of comonomer distribution profile divided by the standard deviation of comonomer distribution profile from the peak temperature (Tp).

CDC is calculated according to the following steps:

Obtain weight fraction at each temperature (T) (w_{T}(T)) from 35.0° C. to 119.0° C. with a temperature step of 0.200° C. from CEF according Equation 2.

$${\int }_{35}^{119.0} {w}_{T} ( T ) d T = 1 \qquad Equation 2$$

Calculate the mean temperature (Tₘₑₐₙ) at cumulative weight fraction of 0.500 (Equation 3)

$${\int }_{35}^{{T}_{mean}} {w}_{T} ( T ) d T = 0.5 \qquad Equation 3$$

Calculate the corresponding median comonomer content in mole % (C_{median}) at the median temperature (T_{median}) by using comonomer content calibration curve (Equation 4).

$$ln ( 1 - comonomercontent ) = - \frac{207.26}{273.12 + T} + 0.5533 \\ {R}^{2} = 0.997 \qquad Equation 4$$

(3i). Comonomer content calibration curve is constructed by using a series of reference materials with known amount of comonomer content. Eleven reference materials with narrow comonomer distribution (mono modal comonomer distribution in CEF from 35.0 to 119.0° C.) with weight average Mw of 35,000 to 115,000 (by conventional GPC) at a comonomer content ranging from 0.0 mole % to 7.0 mole % are analyzed with CEF at the same experimental conditions specified in CEF experimental sections.

(3ii). Comonomer content calibration is calculated by using the peak temperature (Tₚ) of each reference material and its comonomer content. The calibration is: R² is the correlation constant.

Comonomer Distribution Index is the total weight fraction with a comonomer content ranging from 0.5*C_{median} to 1.5*C_{median}. If T_{median} is higher than 98.0° C., Comonomer Distribution Index is defined as 0.95.

Maximum peak height is obtained from CEF comonomer distribution profile by searching each data point for the highest peak from 35.0° C. to 119.0° C. (if the two peaks are identical then the lower temperature peak is selected) Half width is defined as the temperature difference between the front temperature and the rear temperature at the half of the maximum peak height. The front temperature at the half of the maximum peak is searched forward from 35.0° C., while the rear temperature at the half of the maximum peak is searched backward from 119.0° C. In the case of a well defined bimodal distribution where the difference in the peak temperatures being equal to or larger than 1.1 times of the sum of half width of each peak, the half-width of the polymer is calculated as the arithmetic average of the half width of each peak.

The standard deviation of temperature (Stdev) is calculated according Equation 5:

$$Stdev = \sqrt{{\sum }_{35.0}^{119.0} {( T - {T}_{p} )}^{2} * {w}_{T} ( T )} \qquad Equation 5$$

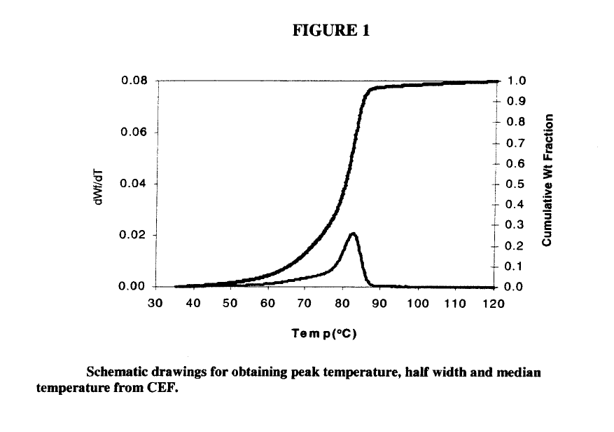

An example of comonomer distribution profile is shown in the diagram in FIG. 1.

### Complex Viscosity (Use Dynamic Melt Viscosity) Also Known as Eta

The dynamic melt viscosity was calculated from DMS measurements between 0.1 Radians/sec to 100 Radians/sec as outlined in section on DMS.

### Tan Delta

Tan delta was calculated from G′ and G″ as follows:

Tan δ=G″/G′

### EXAMPLES

The following examples are used:

| | | Comparative | Comparative | Comparative | Comparative |
|---|---|---|---|---|---|
| | Inventive | Example 1 | Example 2 | Example 3 | Example 4 |
| Property | Example | (PT7009) | (ASPUN ™ 6834) | (DOWLEX ™ 2045) | (ATTANE ™ 4606G) |
| MI | 15.0 | 8.7 | 17.0 | 1.0 | 3.0 |
| Density | 0.920 | 0.918 | 0.950 | 0.920 | 0.912 |
| Tan delta at 0.1 rad/s | 24.4 | 8.0 | 44.20 | 8.61 | 24.71 |
| Eta at 0.1 rad/s (Poise) | 968 | 1836 | 424 | 9352 | 2692 |
| Eta at 100 rad/s (Poise) | 225 | 255 | 263 | 1654 | 900 |
| CDC | 64.7 | 114.5 | 82.8 | 43.8 | 37.8 |
| Tp (Peak recrystallization | 97 | 95 | 115 | 105 | 100 |
| temp) ° C. (From DSC) | | | | | |
| Fiber Spinning | Excellent | Medium | Excellent | Good | Good |
| Fibers Stickiness | Low | Low | Low | High | High |
| Bonding to substrate | Excellent | low | AT high Temp | low | low |
| | at low temp | | | | |
| Airlaid process | Good | Difficult | Good | low | low |
| Fiber Texturizing | Good | Medium | Good | Difficult | Difficult |

In general for this application, a series of performance attributes are needed. First of all, the resin must be capable of forming a fiber in molten state at economically viable rates. Secondly, the resin must be sufficiently good at forming a good bonding onto the core fiber. Third, the resin must have a low enough melting point for good airlaid process as well as for thermal air bonding to other substrates like cellulose. If the Tp is too high, airlaid process is compromised as well as poor thermal air bonding properties. If Tp is too low, then sticking of fibers becomes an issue. In fact, a relatively narrow melting range is ideal.

The inventive example in Table 1 is made with the following specific parameters of reaction. In a two zone tubular high pressure free radical polymerization reactor all of the ethylene is fed into the first zone at a pressure of 2470 bars. A mixture of 14.1% tertiary butyl peroxy octoate (by weight) and 2.8% ditertiary butyl peroxide (by weight) is fed into the first zone of the reactor in an inert solvent typically used for such mixtures. The first zone initiation temperature is 136° C. and the peak temperature of the first zone is 310° C. Also to the first zone of the reactor, a mixture of methyl ethyl ketone of 1280 volume ppm and propylene of 2.1 volume % in an inert solvent is added. To the second reaction zone a mixture of 7% (by volume) tertiary butl peroxyoctoate and 7% (by volume) ditertiary butyl peroxide is added, dissolved in an inert solvent. No chain transfer addition to second reaction zone is done. The inlet temperature to the second reaction zone is 194° C. and the peak temperature for the second zone is 317° C. The total conversion of ethylene at the outlet of the reactor is 28.7% based on the total ethylene fed at the start of reaction zone 1. The polymer is then devolatilized to remove unreacted ethylene, inert solvents and other impurities and then pelletized. The pellets are used as-is without further modification.

Comparative example 1 is a low density polyethylene resin commercially available from The Dow Chemical Company as LDPE PT7009.

Comparative example 2 is a Ziegler Natta based High Density Polyethylene (HDPE) commercially available as ASPUN™ 6934 resin, also from The Dow Chemical Company.

Comparative Example 3 is a Ziegler Natta linear low density polyethylene resin (LLDPE) commercially available from The Dow Chemical Company as DOWLEX™ 2045 resin.

Comparative Example 4 is a Ziegler Natta ultra low density linear low density polyethylene resin (ULLDPE) commercially available from the Dow Chemical Company as ATTANE™ 4606 resin.

It was found that only comparative examples 1, 2 and the inventive example could be made into fibers satisfactorily. While comparative example 2 was good in fiber forming due to its high recrystallization temperature it did not bond well to fibers at desirable low temperatures. Adequate bonding of this comparative example could only be made at higher temperatures.

Comparative examples 3 and 4 were not adequate in fiber forming as their eta 0.1 and eta 100 values were too high for high speed economical fiber forming.

While Comparative example 1 was satisfactory in terms of fiber forming, airlaid process as well as heated air bonding, it was inferior to inventive example in texturizing. It was observed that it did not bond well to the substrate fiber. It was surprisingly found that a good bonding to the substrate fiber requires that the ratio of G″ and G′ (tan delta) must be in a certain range. If tan delta is too low then the sheathing resin is too elastic and does not provide good bonding, as was the case with comparative example 1. If tan delta is too high then the sheathing resin is not elastic enough to make a good bonding to the substrate fiber. Without good bonding between the sheathing resin and the substrate fiber no adequate texturizing is obtained.

Additionally, we found that if a resin has a CDC value less than 45, sticking of fibers takes place at a given peak recrystallization temperature.

We claim:

1. An ethylene-based polymer composition characterized by a Comonomer Distribution Constant greater than about 45, a recrystallization temperature between 85° C. and 110° C., a tan delta value at 0.1 rad/sec from about 15 to 50, and a complex viscosity at 0.1 rad/second of 1400 Pa·sec or less.

2. The composition of claim 1 wherein the Comonomer Distribution Constant is in the range of 45 to 400.

3. The composition of claim 1 wherein the Comonomer Distribution Constant is in the range of 50-100.

4. The composition of claim 1 wherein the Comonomer Distribution Constant is in the range of 55-100.

5. The composition of claim 1 wherein the tan delta value at 0.1 rad/sec from about 15 to 40.

6. The polymer composition of claim 1 wherein the composition has a complex viscosity at 100 rad/seconds of 500 Pa·sec or less.

7. The polymer composition of claim 1 wherein the composition has a recrystallization temperature of 90° C. to 105° C.

8. The polymer composition of claim 1 wherein the composition is further characterized by having from about 0.2 to about 3 long chain branches/1000 carbons.

9. The polymer composition of claim 1 further comprising a single DSC melting peak.

10. The composition of claim 1 further comprising one or more additional polyolefin materials.

11. The composition of claim 1 further comprising an additive selected from the group consisting of plasticizers, stabilizers, ultraviolet light absorbers, antistatic agents, pigments, dyes, nucleating agents, fillers, slip agents, fire retardants, plasticizers, processing aids, lubricants, stabilizers, smoke inhibitors, viscosity control agents, surface modification, anti-blocking agents, and combinations thereof.

12. A process to make the composition of claim 1 wherein the composition is made using two or more reactors, one of which is a back mixed reactor with at least one reaction zone and a second reactor which is a laminar flow reactor with at least two reactions zones.
